(19) United States
(12) Patent Application Publication
(10) Pub. No.: US 2013/0223083 A1
(43) Pub. Date: Aug. 29, 2013

(54) Lamp Apparatus and Luminaire

(71) Applicant: Toshiba Lighting & Technology Corporation, (US)

(72) Inventors: Junichi Kimiya, Kanagawa (JP); Kunihiko Ikada, Kanagawa (JP); Go Kato, Kanagawa (JP); Kenji Nezu, Kanagawa (JP)

(73) Assignee: TOSHIBA LIGHTING & TECHNOLOGY CORPORATION, Yokosuka-shi (JP)

(21) Appl. No.: 13/780,727

(22) Filed: Feb. 28, 2013

(30) Foreign Application Priority Data
Feb. 28, 2012 (JP) 2012-041092

(51) Int. Cl. F21V 29/00

(52) U.S. Cl. CPC F21V 29/2206
USPC 362/382

(57) ABSTRACT

A lamp apparatus includes a body, a light-emitting module, a lighting device, a cap unit, and an insulating member. The body has thermal conductivity, and is provided with a base unit, a cylindrical portion extending upright in a substantially cylindrical shape from the back side of the base unit, and a plurality of thermal radiation fins formed on the back side of the base unit. The light-emitting module is disposed on a front side of the base unit of the body. The lighting device performs lighting control on the light-emitting elements, and is disposed inside the cylindrical portion of the body. The cap unit includes a pair of electrode pins and covers the lighting device. The insulating member is disposed inside the cylindrical portion of the body and includes an upright portion extending upright from a peripheral edge thereof.

### CROSS-REFERENCE TO RELATED APPLICATION

This application is based upon and claims the benefit of priority of the prior Japanese Patent Application No. 2012-041092 filed on Feb. 28, 2012, the entire contents of which are incorporated herein by reference.

### FIELD

Embodiments described herein relate generally to a lamp apparatus that uses a light-emitting element such as an LED (Light Emitting Diode) as a light source and a luminaire.

### BACKGROUND

In the related art, a lamp apparatus using a light-emitting element as a light source and being expected to have low power consumption and a long service life is developed. For example, there is a lamp apparatus having an IEC (International Electrotechnical Commission) standardized GX53-type cap and reduced in thickness. This lamp apparatus uses a light-emitting module including a plurality of light-emitting elements mounted on a substrate.

The light-emitting elements such as LEDs generate heat while being lit. The generated heat increases the temperature of the light emitting elements, and correspondingly, an output of light is lowered, and the service life is shortened. Therefore, the lamp apparatus having solid light-emitting elements such as the LEDs or EL (Electroluminescence) elements as light sources is required to restrict temperature rise of the light-emitting elements in order to elongate the service life or improve characteristics such as light-emitting efficiency.

In the lamp apparatus using the light-emitting module as described above, enhancement of a dielectric withstanding voltage and securement of predetermined insulation performance are required, while efficient radiation of heat generated by the light-emitting element to the outside is required.

### DESCRIPTION OF THE DRAWINGS

FIG. 1 illustrates a perspective view of a lamp apparatus according to a first embodiment;

FIG. 2 illustrates a plan view of the lamp apparatus viewed from the back side;

FIG. 3 is a cross-sectional view taken along the line X-X in FIG. 2;

FIG. 4 is an enlarged view illustrating a portion surrounded by a broken line in FIG. 3;

FIG. 5 is an exploded perspective view viewed from the back side;

FIG. 6 is an exploded perspective view viewed from the front side;

FIG. 7 is a plan view illustrating a light-emitting module;

FIG. 8 is a plan view illustrating a wiring pattern layer;

FIG. 9A is a schematic drawing for explaining part of a manufacturing process;

FIG. 9B is a schematic drawing for explaining part of a manufacturing process of the lamp apparatus of a comparative example;

FIG. 10A is a schematic drawing for explaining part of the manufacturing process of the first embodiment;

FIG. 10B is a schematic drawing for explaining part of the manufacturing process of the comparative example;

FIG. 11 is a cross-sectional view of a luminaire illustrating a state in which the lamp apparatus according to the first embodiment is mounted thereon;

FIG. 12 illustrates a perspective view of an insulating member according to a second embodiment; and

FIG. 13 is an enlarged view of an air-ventilation route of the second embodiment.

### DETAILED DESCRIPTION

A lamp apparatus according to embodiments includes a body, a light-emitting module, a lighting device, a cap unit, and an insulating member. The body has thermal conductivity, and is provided with a base unit, a cylindrical portion extending upright in a substantially cylindrical shape from the back side of the base unit, and a plurality of thermal radiation fins formed on the back side of the base unit. The light-emitting module is disposed on the front side of the base unit of the body. The lighting device performs lighting control on light-emitting elements, and is disposed inside the cylindrical portion of the body.

The cap unit includes a pair of electrode pins and covers the lighting device. The insulating member is disposed inside the cylindrical portion of the body and includes an upright portion extending upright from a peripheral edge thereof.

Referring now to the drawings, the lamp apparatus and a luminaire according to the embodiments will be described. In the respective embodiments, the same portions are denoted by the same reference numerals and overlapped description will be omitted.

### First Embodiment

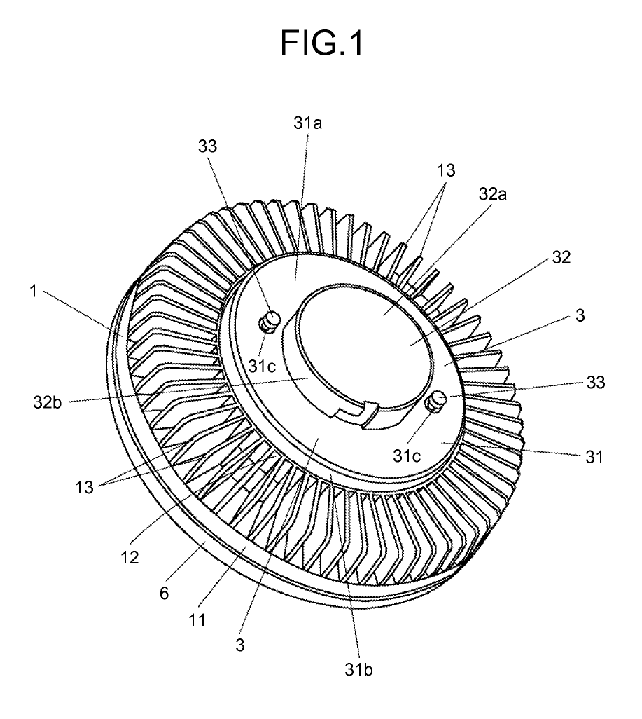

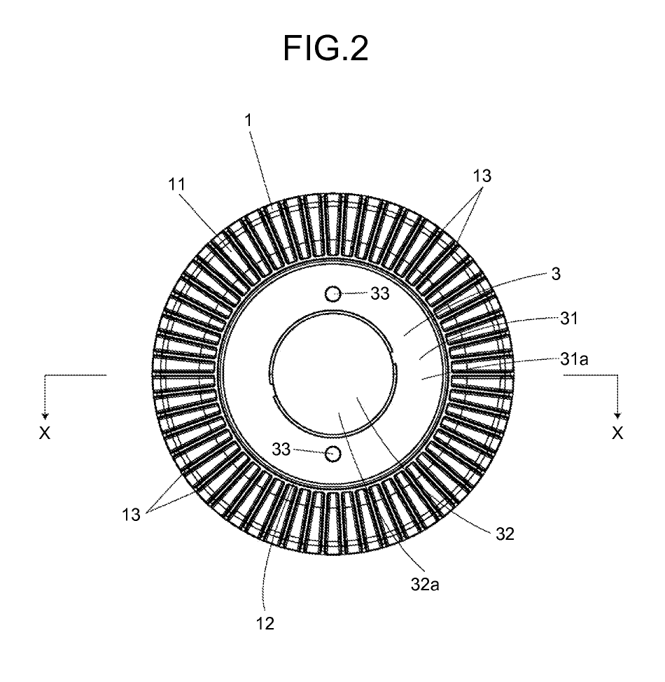

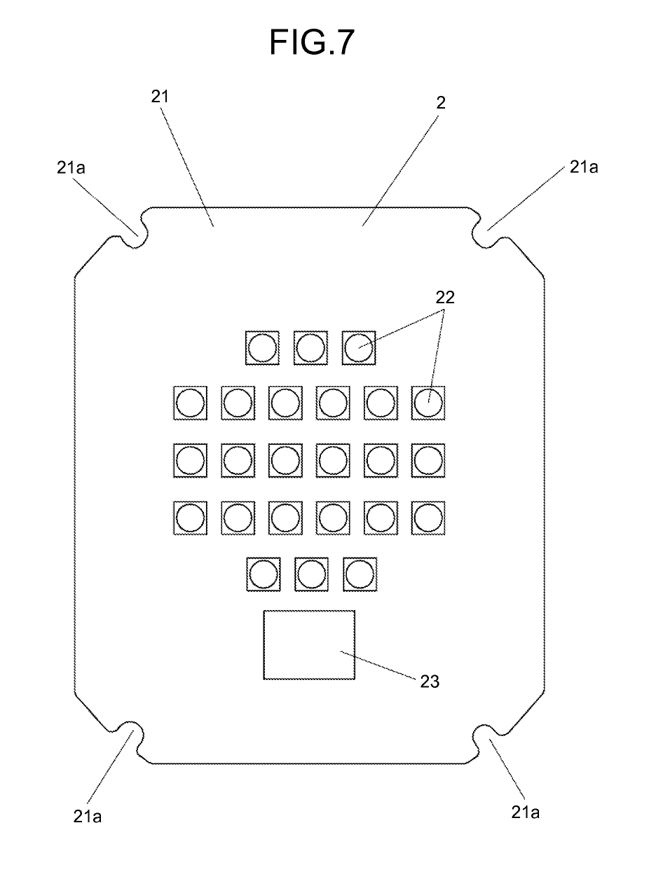

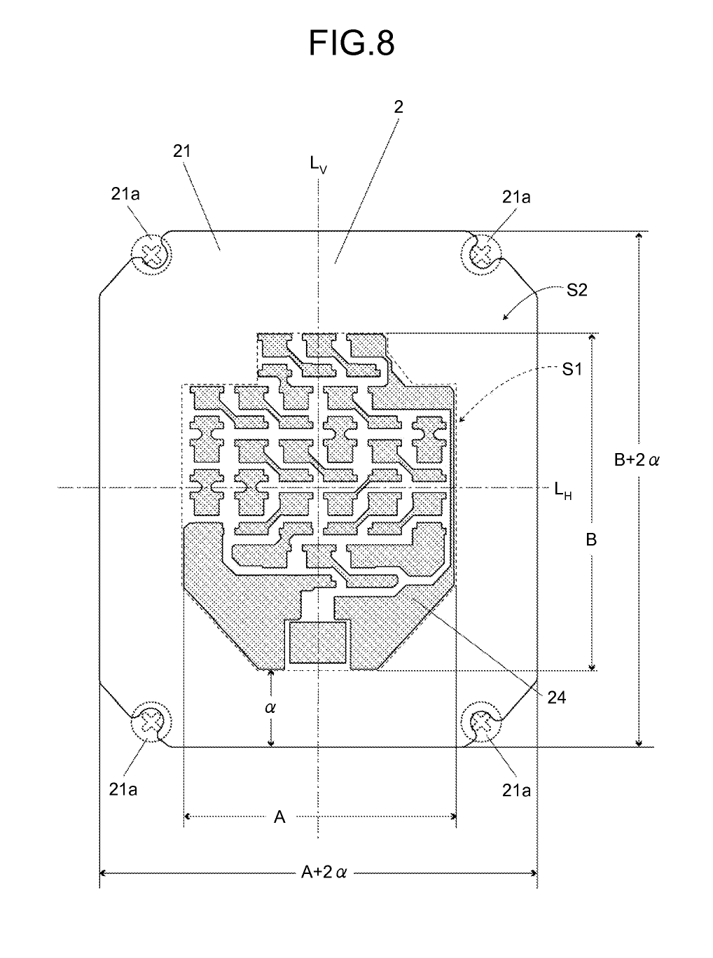

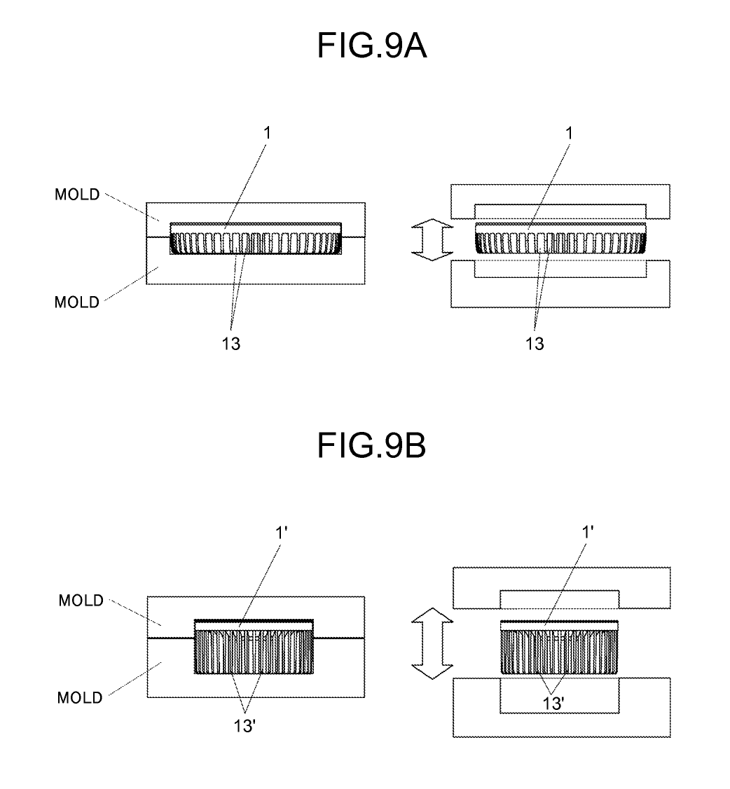

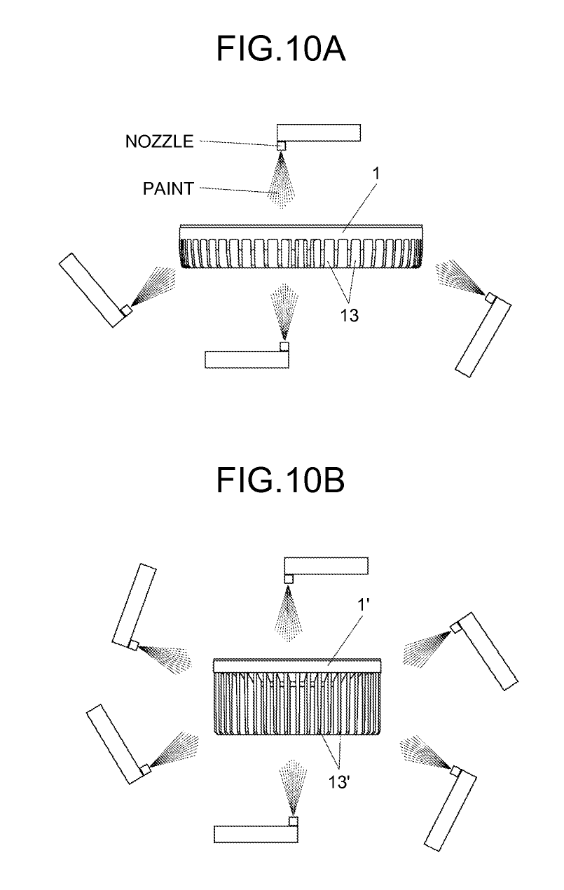

Referring now to FIG. 1 to FIG. 10B, the lamp apparatus according to a first embodiment will be described. FIG. 1 to FIG. 6 illustrate the lamp apparatus, and FIG. 7 and FIG. 8 illustrate a light-emitting module. FIG. 9A, FIG. 9B, FIG. 10A, and FIG. 10B illustrate parts of a manufacturing process in the first embodiment and a comparative example. In respective drawings, the same parts are denoted by the same reference numerals and overlapped description will be omitted.

As illustrated in FIG. 1 to FIG. 6, the lamp apparatus includes a body 1, the light-emitting module as a light source unit 2, a cap unit 3, a lighting device 4, an insulating member 5, and a globe 6. The lamp apparatus is formed to have a substantially thin disk-shaped appearance. In the following explanation, a side of the lamp apparatus radiating light to the outside (radiating surface) is referred to as a front side, and the side opposite to the front side and on which the lamp apparatus is mounted in a socket of a luminaire (mounting surface) is referred to as a back side.

The body 1 has thermal conductivity, and is formed of a material having a good rate of thermal conductivity such as aluminum alloy through die-cast molding. The body 1 integrally includes a base unit 11, a cylindrical portion 12, and thermal radiation fins 13, and is applied with white coating.

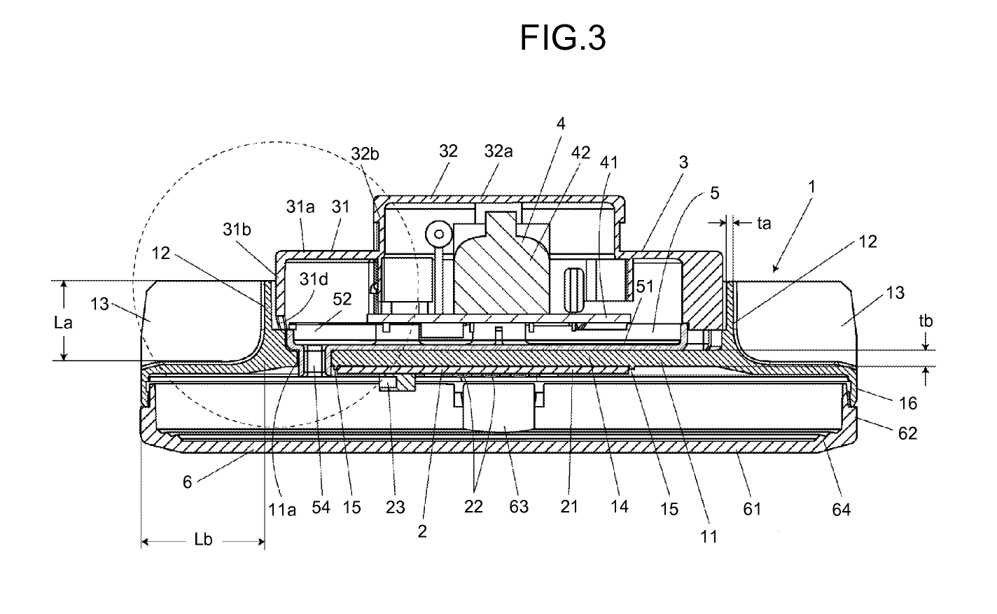

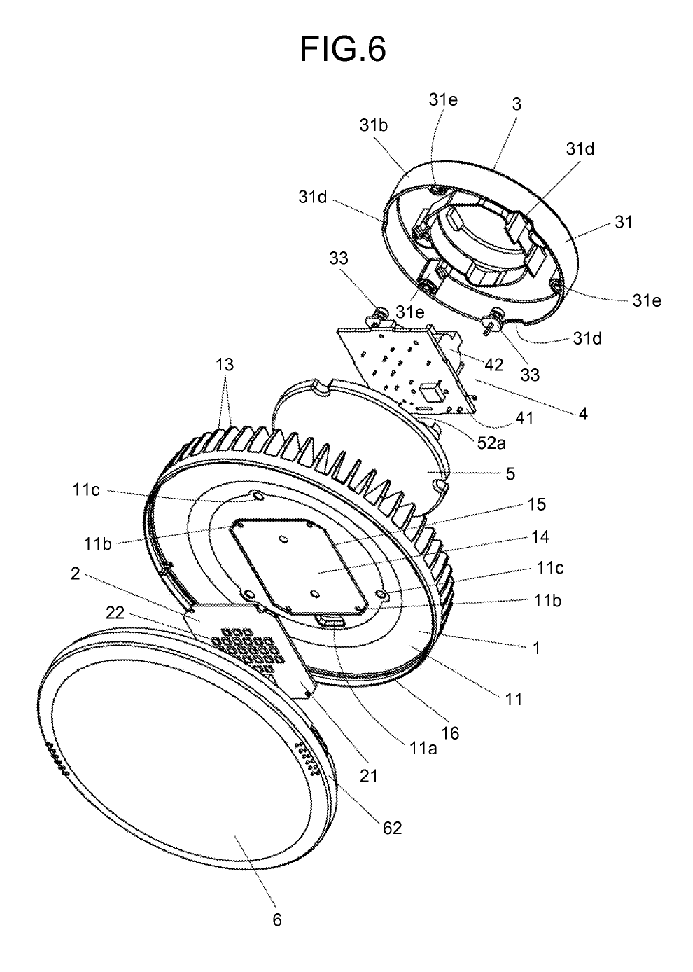

The base unit 11 is formed into a substantially disk shape, and is formed with a mounting surface 14 of the light source unit 2 on the front side thereof and is formed with a cylindrical portion 12 and a plurality of thermal radiation fins 13 on the back side thereof. The mounting surface 14 is formed into a thick circular plate as illustrated in FIG. 3 and FIG. 6. The mounting surface 14 is formed with a protruding wall 15 at a center portion thereof. The protruding wall 15 protrudes into a rib shape so as to surround the circumference of a portion where the light source unit 2 is disposed into a substantially square shape.

With the provision of the protruding wall 15, for example, when the body 1 is coated by electrostatic coating, inflow of paint into the protruding wall 15, that is, into the portion where the light source unit 2 is disposed may be restricted. In other words, the electrostatic coating on the body 1 is performed by arranging a jig on the mounting surface 14 to prevent the mounting surface 14 from being coated. Then, after the coating, the body 1 is heated to fix the paint. Here, the jig needs to be removed from the body 1 before heating the body 1. However, when removing the jig, a negative pressure is generated between the mounting surface 14 and the jig, and hence a phenomenon that the paint adhered around the mounting surface 14 is sucked into the mounting surface 14 side occurs. In the first embodiment, since the protruding wall 15 is formed around the mounting surface 14, the sucking of the paint as described above is restricted, and adherence of the paint to the mounting surface 14 may be reduced. Therefore, hindrance of thermal conduction due to the interposition of the paint between the light source unit 2 and the mounting surface 14 maybe prevented, while coating of portions other than the portion where the light source unit 2 is disposed is reliably achieved.

A cylindrical globe fitting portion 16 is formed on an outer peripheral portion of the base unit 11 on the front side.

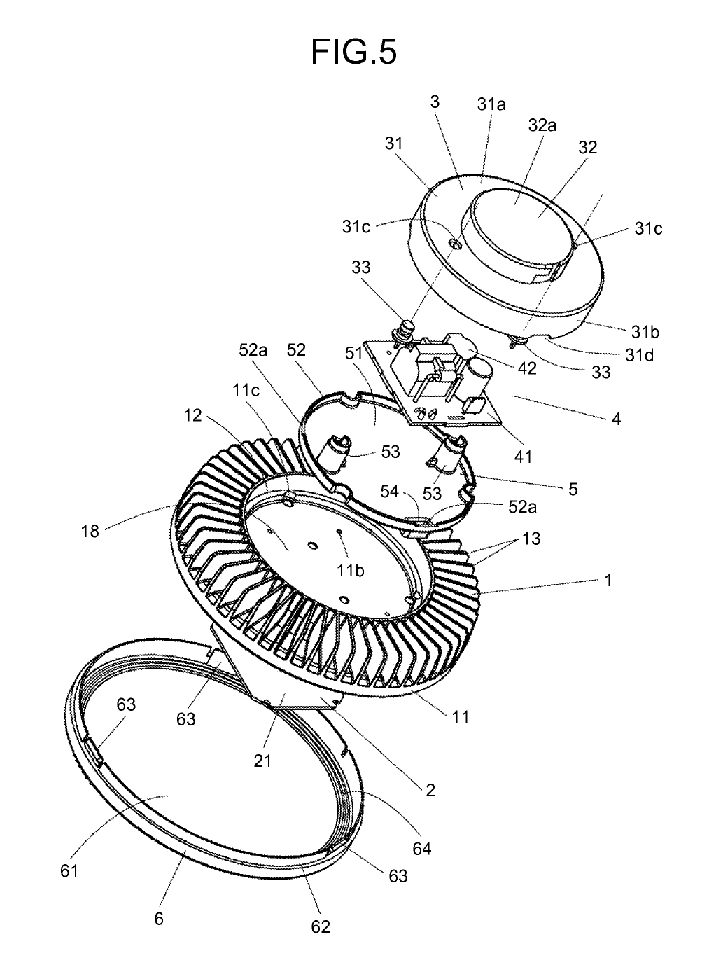

As illustrated in FIG. 1 to FIG. 3 and FIG. 5, the cylindrical portion 12 extending upright into a substantially cylindrical shape is formed on the back side of the base unit 11. With the provision of the cylindrical portion 12, an installation depression 18 (see FIG. 5) is formed inside thereof. The installation depression 18 is configured to accommodate the lighting device 4.

As illustrated in FIG. 1 to FIG. 6, a plurality of the thermal radiation fins 13 are provided so as to extend upright in the vertical direction from the back side of the base unit 11.

Specifically, the thermal radiation fins 13 are connected to an outer periphery of the cylindrical portion 12 and the back side of the base unit 11, and are disposed so as to extend radially from the outer periphery of the cylindrical portion 12. As illustrated in FIG. 3 as a representative, the thermal radiation fins 13 are each formed into a substantially rectangular plate shape, and the adjacent thermal radiation fins 13 are disposed at substantially regular intervals with respect to each other.

In the thermal radiation fins 13 configured as described above, the length of portions connected on the back side of the base unit 11, that is, a connecting length Lb is larger than the length of portions connected on the outer periphery of the cylindrical portion 12, that is, a connecting length La, and hence a dimensional relationship La<Lb is established, as illustrated in FIG. 3 as a representative.

In addition, a thickness tb of the mounting surface 14 is larger than a thickness ta of the cylindrical portion 12, so that a dimensional relationship of ta<tb is established.

The thickness of the base unit 11 to which the thermal radiation fins 13 are connected may be formed to be the same as the thickness tb of the mounting surface 14 and to be larger than the thickness ta of the cylindrical portion 12.

The mounting surface 14 of the light source unit 2 on the base unit 11 is formed with a wiring hole 11a, through holes 11b, and through holes 11c. The wiring hole 11a is a square hole for allowing passage of an electric wire for electrically connecting the light source unit 2 and the lighting device 4 to pass through. The through holes 11b are holes which allow mounting screws, not illustrated, for mounting the light source unit 2 to the mounting surface 14 to pass therethrough. The through holes 11c are holes which allow mounting screws for mounting the cap unit 3 to the back side of the body 1 to pass therethrough.

As illustrated in FIG. 3, FIG. 6 to FIG. 8, the light source unit 2 is composed of the light-emitting module, and includes a substrate 21, and a plurality of light-emitting elements 22 mounted on the substrate 21. The substrate 21 is formed of a metallic base substrate having an insulative layer laminated over the entire surface of the base board having desirable thermal conductivity and superior in thermal radiation property such as aluminum and formed into a substantially square shape. On the insulative layer, a wiring pattern layer 24 formed of a copper foil is formed and a white resist layer is laminated as needed.

Furthermore, the substrate 21 includes a connector 23 disposed thereon and an output line, not illustrated, of the lighting device 4 is connected to the connector 23.

Specifically, as illustrated in FIG. 7 and FIG. 8, the substrate 21 is formed into a substantially rectangular shape having corners cut off. The substrate 21 is formed with screw mounting through holes 21a cut out into an arc-like shape so as to open outward at the corners thereof.

The wiring pattern layer 24 is formed so as to form a polygonal shape over the entire surface of the substantially center portion of the substrate 21. This area is composed of a large number of block-shaped patterns, and the plurality of light-emitting elements 22 and the connector 23 are electrically connected to the respective block-shaped patterns.

The substrate 21 of the first embodiment is formed so that a minimum distance α from an outer peripheral end of the substrate 21 to the wiring pattern layer 24 is at least 4 mm. In other words, the periphery of the area having the wiring pattern layer 24 as a charging portion formed thereon is formed so as to keep a distance of at least 4 mm from the outer peripheral end of the substrate 21 in order to secure a creeping distance to maintain insulation performance. Accordingly, securement of the insulating property is enabled without providing, for example, a specific insulating member interposed between the back side of the substrate 21 and the body 1 on which the substrate 21 is mounted, so that the number of components may be reduced.

Specifically, a portion of the wiring pattern layer 24 where the distance from the outer peripheral end of the substrate 21 to the wiring pattern layer 24 is minimum is a portion where the connector 23 is connected, and the wiring pattern layer 24 is formed so that the minimum distance α of at least this portion is at least 4 mm. In the first embodiment, the minimum distance α is on the order of 7 mm.

The ratio between a surface area S1 of the area in which the wiring pattern layer 24 is formed and a surface area S2 of the substrate surface is set to be at least 1:1+(4α²+2α(A+B))/AB or larger, where A and B are maximum widths of areas in which the wiring pattern layer 24 is formed along respective lines substantially orthogonal to each other on the substrate surface, that is, along a horizontal line L_{H} and along a vertical line L_{V}, and α is the minimum distance from the outer peripheral end of the substrate 21 to the wiring pattern layer 24.

In other words, the surface area S1 of the area in which the wiring pattern layer 24 is formed is obtained by approximately A×B. In contrast, the surface area S2 of the substrate surface is obtained approximately by (A+2α)×(B+2α) because the width along the horizontal line L_{H} becomes A+2α, and the width along the vertical line L_{V} becomes B+2α, considering an insulating distance, that is, the minimum distance α from the outer peripheral end of the substrate 21 to the wiring pattern layer 24.

Based on this, the ratio between the surface area S1 of the area in which the wiring pattern layer 24 is formed and the surface area S2 of the substrate surface becomes 1:1+(4α²+2α(A+B))/AB.

Therefore, by defining the surface area S1 of the wiring pattern layer 24 and the surface area S2 of the substrate surface to have a ratio equivalent to or larger than the ratio described above, the insulating property is secured, and the surface area S2 of the substrate surface is set to a predetermined size and improvement of the thermal radiation property is enabled.

In other words, by setting the surface area S2 of the substrate surface to be large, the contact surface area between the back side of the substrate 21 and the body 1 on which the substrate 21 is mounted is increased, so that the desirable thermal conduction is achieved.

In addition, by setting the ratio between the surface area S1 of the area in which the wiring pattern layer 24 is formed and the surface area S2 of the substrate surface to be closer to 1:1+(4α²+2α(A+B))/AB, the surface area S2 of the substrate surface is reduced, and the contact surface area between the back side of the substrate 21 and the body 1 on which the substrate 21 is mounted tends to decrease. Thus, restriction of cost increases is achieved by reducing the substrate 21 in size.

If the relationship between the surface area S1 of the area in which the wiring pattern layer 24 is formed and the surface area S2 of the substrate surface is expressed in other words, the ratio of the surface area S2 of the substrate surface with respect to the surface area S1 of the area in which the wiring pattern layer 24 is formed can be said to be 1+(4α²+2α(A+B))/AB or larger, where A and B are the maximum width dimensions of the areas in which the wiring pattern layer 24 is formed along respective lines L_{H} and L_{V} substantially orthogonal to each other on the substrate surface, and α is the minimum distance from the outer peripheral end of the substrate 21 to the wiring pattern layer 24.

In the description given above, the shape of the substrate 21 is a substantially rectangular shape. However, the shape of the substrate 21 is not specifically limited, that is, the substrate 21 having a substantially square shape, for example, may be applicable, and also the substrate 21 having one side formed into an arc-like shape or the substrate 21 having a pair of opposing sides formed into an arc-like shape is applicable.

In addition, in the same manner, the shape of the area in which the wiring pattern layer 24 is formed is not specifically limited.

The light-emitting elements 22 are LEDs and form a package of an SMD (surface mount device). Schematically, the light-emitting element 22 includes an LED chip disposed on a cavity formed of ceramics or a synthetic resin and a translucent resin for molding such as an epoxy resin or a silicone resin for sealing the LED chip. A plurality of the LEDs of the type described above are mounted on the substrate 21.

The LED chip is a blue LED chip emitting blue light. The translucent resin is mixed with fluorescent material, and yellow fluorescent material which emits yellowish light which is in a compensating relationship with the blue light is used in order to allow emission of white light.

The mounting method or the form is not specifically limited and the LEDs may be configured by mounting the LED chips directly on the substrate in a COB (chip on board) system.

In the light-emitting module as described above, the wiring pattern layer 24 on the substrate 21 is formed so that the minimum distance α from the outer peripheral end of the substrate 21 is at least 4 mm. The ratio of the surface area S2 of the substrate surface with respect to the surface area S1 of the area in which the wiring pattern layer 24 is formed is defined to be 1+(4α²+2α(A+B))/AB or larger. In this configuration, the insulation performance is secured, and the realization of the preferable light-emitting module which achieves improvement of thermal radiation is enabled.

The substrate 21 is arranged so as to be surrounded by the protruding wall 15 on the mounting surface 14 of the base unit 11 and is disposed by being secured with screws. Therefore, a side surface of the substrate 21 is arranged and positioned by being guided by the protruding wall 15. Therefore, the operation to arrange the substrate 21 may be performed efficiently. The back side of the substrate 21 is in tight contact with the mounting surface 14, and is thermally coupled thereto.

As illustrated in FIG. 1 to FIG. 3, FIG. 5 and FIG. 6, the cap unit 3 is manufactured to have a GX53-type cap structure under the IEC standard, and includes a cap unit body 31, a protruding portion 32, and a pair of electrode pins 33.

The cap unit body 31 and the protruding portion 32 are formed integrally of a synthetic resin such as a PBT (polybutylene terephthalate) resin or the like, so as to have flat back walls 31a and 32a and cylindrical side walls 31b and 32b, respectively. The protruding portion 32 protrudes toward the back side in a center portion of the back wall 31a of the cap unit body 31, and is formed to have a size insertable into an insertion hole of a socket apparatus, not illustrated.

The pair of electrode pins 33 are formed, for example, of brass, each having a distal end portion formed to have a large diameter, and fitted into a hole 31c formed on the back wall 31a of the cap unit body 31 from the inside. The electrode pins 33 are provided on the surface of the back wall 31a so as to protrude therefrom at positions adjacent to the protruding portion 32 and opposing each other with the protruding portion 32 interposed therebetween.

The pair of the electrode pins 33 are connected to input terminals of the lighting device 4 in the interior of the cap unit body 31. The pair of the electrode pins 33 as described above are configured to be electrically connected to a pair of receiving metals of the socket apparatus, not illustrated.

As illustrated in FIG. 3 to FIG. 6, air-ventilation ports 31d are formed at an opening edge of the side wall 31b of the cap unit body 31. The air-ventilation ports 31d are a plurality of notched ports notched into a substantially trapezoidal shape, are formed at intervals of 120° at the opening edge of the side wall 31b and, specifically, are formed at three positions.

As illustrated in FIG. 6 as a representative, a plurality of bosses 31e are formed so as to protrude on the inside of the cap unit body 31. The plurality of bosses 31e are formed at intervals of 120° circumferentially of the cap unit body 31. The bosses 31e are each formed with a screw hole, and a mounting screw, not illustrated, is screwed into the screw hole of the boss 31e via the insulating member 5 from the front side of the base unit 11 of the body 1.

Accordingly, the lighting device 4 and the insulating member 5 are disposed and integrated between the back side of the body 1 and the front side of the cap unit 3.

As illustrated in FIG. 3, FIG. 5, and FIG. 6, the lighting device 4 includes a circuit substrate 41 and lighting circuit components 42 mounted on the circuit substrate 41. The circuit substrate 41 is formed of a synthetic resin substrate such as a glass epoxy resin and formed into a substantially square shape, and accommodates the lighting circuit components 42 including a resistance, a electrolytic capacitor, a transformer, and a semiconductor element, mounted thereon.

The circuit substrate 41 includes an input terminal and an output terminal, not illustrated, disposed thereon. The pair of electrode pins 33 are connected to the input terminal so that an AC voltage (for example, AC 100V) of an external power source is input to the lighting device 4. An output line to be connected to the connector 23 of the light source unit 2 is connected to the output terminal.

The lighting device 4 is formed with a lighting circuit composed of the lighting circuit components 42. The lighting circuit performs lighting control on the light-emitting elements 22. Therefore, when the external power source is supplied to the lighting device 4, the lighting device 4 is activated to smoothen and rectify the AC voltage of the external power source, converts the smoothened and rectified AC voltage into a predetermined DC voltage, and supplies a constant current to the light-emitting elements 22.

The lighting device 4 configured in such a manner is disposed inside the cylindrical portion 12 of the body 1. Specifically, the lighting device 4 is disposed in the installation depression 18 defined by the cylindrical portion 12 via the insulating member 5 and is accommodated in a state in which the back side is covered with the cap unit 3.

As illustrated in FIG. 3 to FIG. 6, the insulating member 5 is formed, for example, of a PBT (polybutylene terephthalate) resin, and is formed into a shallow dish shape having a flat bottom plate portion 51 and an upright portion 52 formed so as to extend upright from the peripheral edge of the bottom plate portion 51. In addition, notched ports 52a are formed at three positions at intervals of 120° on an edge portion of the upright portion 52.

The insulating member 5 is arranged on the back side of the body 1, that is, in the installation depression 18 on the inside of the cylindrical portion 12, and mainly has a function to insulate the body 1 from the lighting device 4. Since the upright portion 52 is formed on the peripheral edge of the insulating member 5, improvement of the strength of the plate-shaped insulating member 5 is enabled. The upright portion 52 is configured to act as air-ventilation resistance of an air-ventilation route, as described later.

In addition, the bottom plate portion 51 of the insulating member 5 is formed with a cylindrical projecting portion 53 configured to support the pair of the electrode pins 33 from the back side and a square-column-shaped insulating cylindrical portion 54 configured to maintain the insulating property by penetrating through the wiring hole 11a formed on the body 1.

As illustrated in FIG. 3, FIG. 5, and FIG. 6, the globe 6 is mounted on the globe fitting portion 16 of the body 1. The globe 6 is formed, for example, of a PC (poly carbonate) resin having light translucency so as to have a bottomed flat cylindrical shape, and includes a flat surface portion 61, a side wall portion 62, and locking strips 63.

The flat surface portion 61 has a circular shape, and both inner and outer surfaces thereof are formed into a flat surface shape, respectively. The side wall portion 62 is formed continuously on the outer peripheral edge of the flat surface portion 61 so as to extend circumferentially thereof, and is formed so as to be upright at a substantially right angle with respect to the flat surface portion 61.

In addition, the flat surface portion 61 is formed with Fresnel lenses 64 on an outer peripheral portion on the inner side of the flat surface portion 61. A plurality of the Fresnel lenses 64 are formed concentrically with a center at a center portion of the flat surface portion 61, and includes projections and depressions formed into a substantially triangular shape in cross section. Light emitted from the light-emitting module by the Fresnel lenses 64 is radiated toward the front side in the form of parallel light, for example.

The locking strips 63 are formed on the side wall portion 62 continuously at intervals of 120° and extend upright at a substantially right angle with respect to the flat surface portion 61, and each includes a claw portion at the distal end side thereof. Then, the globe 6 is mounted on the body 1 by fitting the side wall portion 62 into the inner peripheral surface of the globe fitting portion 16 of the body 1 and causing claw portions of the locking strip 63 to be locked to a locking depression formed on the inner peripheral side of the globe fitting portion 16.

In this manner, the flat surface portion 61 of the globe 6 opposes the light source unit 2, and covers the front side of the body 1.

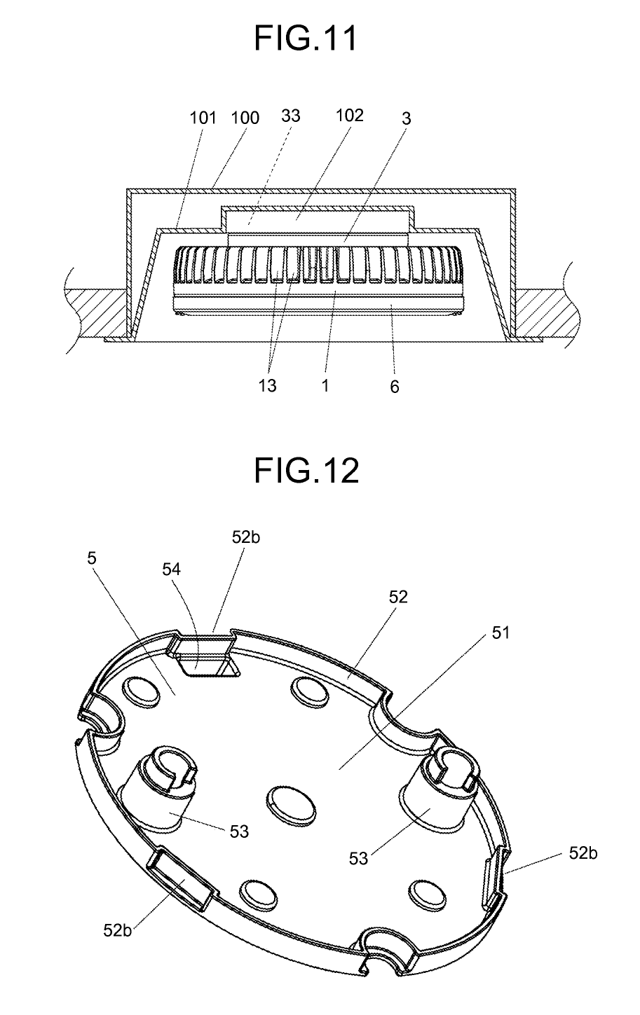

Subsequently, the luminaire on which the lamp apparatus is mounted will be described with reference to FIG. 11. The luminaire is, for example, a down light which is installed in a depression of the ceiling surface. The down light includes an apparatus body 100, a reflecting plate 101, a socket apparatus 102, and the lamp apparatus mounted on the socket apparatus 102.

The apparatus body 100 is formed into a box-shape having an opening on the lower end side thereof, and the reflecting plate 101 formed with a reflecting surface by white coating, for example, is accommodated in the apparatus body 100. The socket apparatus 102 is disposed at a center portion of the reflecting plate 101, and an annular flange portion extending outward is formed at an opening edge portion of the reflecting plate 101.

The socket apparatus 102 is formed into a configuration in which the cap unit 3 as a GX53-type cap is to be mounted. The lamp apparatus is fixed to the socket apparatus 102 by inserting the protruding portion 32 of the cap unit 3 into an insertion hole, not illustrated, of the socket apparatus 102, inserting the pair of electrode pins 33 thereof into a pair of connecting holes, not illustrated, of the socket apparatus 102, and then being rotated. Simultaneously, the pair of electrode pins 33 are electrically connected to a pair of receiving metals, not illustrated, of the socket apparatus 102. In other words, the pair of electrode pins 33 are configured to be mechanically and electrically connected to the socket apparatus 102.

Subsequently, the operation of the first embodiment will be described. When power is supplied to the lighting device 4 via the socket apparatus 102, the lighting device 4 is activated and the light-emitting elements 22 emit light. Major part of white light emitted from the respective light-emitting elements 22 passes through the globe 6, is radiated outward from the opening of the reflecting plate 101 of the apparatus body 100, and is applied to an irradiated surface, for example, a floor.

Heat is generated while the light-emitting elements 22 emit light. The heat generated by the light-emitting elements 22 is transferred mainly from the back side of the substrate 21 through the mounting surface 14 of the base unit 11 of the body 1 to the thermal radiation fins 13, and is radiated in association with convection acting at predetermined intervals between the respective thermal radiation fins 13.

In this case, the wiring pattern layer 24 on the substrate 21 is formed so that the minimum distance α from the outer peripheral end of the substrate 21 is at least 4 mm, and the ratio of the surface area S2 of the substrate surface with respect to the surface area S1 of the area in which the wiring pattern layer 24 is formed is set to the predetermined value as described above. Therefore, the insulation performance is secured, and realization of the preferable light-emitting module which achieves improvement of thermal radiation is achieved.

The lighting device 4 which is a heat generating source is disposed inside the cylindrical portion 12 of the base unit 11. Therefore, the cylindrical portion 12 is susceptible to the heat generated from the lighting device 4 and has a tendency to increase in temperature. Therefore, the efficient thermal conduction between the cylindrical portion 12 and the thermal radiation fins 13 via a connecting portion therebetween can hardly be achieved, so that there is a case where the thermal radiation cannot be performed effectively.

When, by way of experiment, the connecting length La of a portion of the thermal radiation fins 13 to be connected to the outer periphery of the cylindrical portion 12 is increased, and hence a cross-sectional area of connection between the thermal radiation fins 13 and the cylindrical portion 12 is increased, not only desirable thermal radiating properties cannot be achieved, but also the height of the respective thermal radiation fins is increased, so that the height of the lamp apparatus is increased, and hence the problem of difficulty of realization of thickness reduction arises.

In the first embodiment, the thermal radiation fins 13 have dimensions such that the connecting length Lb connected to the base unit 11 is formed to be larger than the connecting length La of a portion connected to the cylindrical portion 12, and hence a relationship La<Lb is achieved. Therefore, since the cross-sectional area of connection between the thermal radiation fins 13 and the base unit is larger than the cross-sectional area of connection between the thermal radiation fins 13 and the cylindrical portion 12, the thermal conduction from the mounting surface 14 to the thermal radiation fins 13 via a connecting portion between the thermal radiation fins 13 and the base unit is efficiently achieved, the thermal distribution is uniformized, and improvement of the thermal radiation property is enabled. In addition, reduction in the thickness of the lamp apparatus may be maintained.

When the thickness of the base unit 11 to which the thermal radiation fins 13 are connected is set to the size larger than the thickness to of the cylindrical portion 12, thermal conduction is efficiently achieved from the thick mounting surface 14 to the base unit 11 where the thermal radiation fins 13 are connected. With respect to the thermal conduction to the cylindrical portion 12, thermal resistance can be reduced. Hence the thermal distribution may easily be uniformized over the entire portion of the thermal radiation fins 13, and improvement of the thermal radiation property is expected.

Here, if the pressure in a case of a capacitor reaches a pressure higher than a predetermined pressure by evaporative gas generated from the electrolysis solution when an excessive voltage is applied to an electrolytic capacitor, for example, which is the lighting circuit component 42 of the lighting device 4 or in case of emergency in an end stage of the lifetime during the usage of the lamp apparatus, a safety valve is activated in order to prevent the case from blowing out, so that the evaporative gas from the electrolysis solution may spout out.

Activation of the safety valve is a normal operation intended to suppress the abnormal pressure increase in the case. However, since the evaporative gas from the electrolysis solution spouting out looks like smoke, a user is likely to misidentify the phenomenon as smoke caused by burning, and to identify as fire. The spouting smoke-like evaporative gas makes an attempt to flow out from the air-ventilation ports 31d formed in the cap unit body 31.

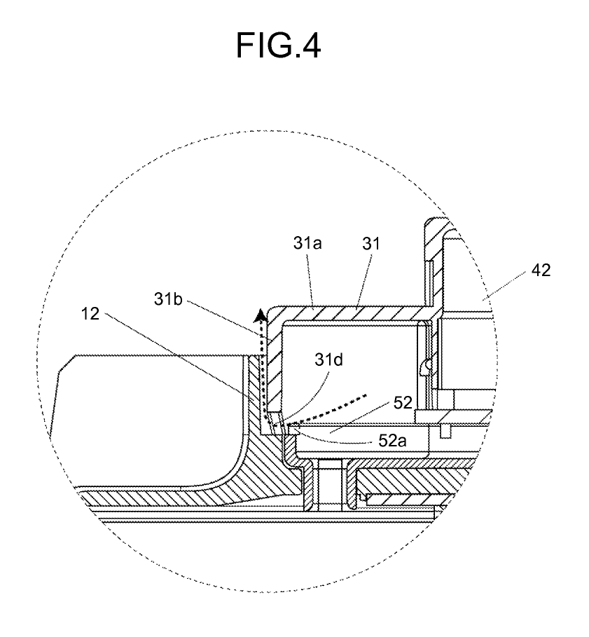

As illustrated in FIG. 4 as a representative, in the first embodiment, the air-ventilation route communicating to the outside via the air-ventilation ports 31d is formed non-linearly. Specifically, as illustrated by an arrow, the air-ventilation path extends from the lighting circuit component 42 through the notched ports 52a of the upright portion 52 of the insulating member 5 positioned so as to face the air-ventilation ports 31d toward the air-ventilation ports 31d, then passes through the air-ventilation ports 31d, and through a gap between the outer peripheral side of the side wall 31b of the cap unit body 31 and the inner peripheral side of the cylindrical portion 12 of the body 1, proceeds toward the outside.

Accordingly, the smoke-like evaporative gas does not flow out from the air-ventilation ports 31d directly outside, comes into contact with the upright portion 52 of the insulating member 5, which functions as air-ventilation resistance, is cooled by coming into contact with the cylindrical portion 12 or the side wall 31b when passing through the gap, and is condensed into a liquid state. Therefore, the evaporative gas does not flow out as-is, and hence is prevented from flowing out in a smoke state.

Subsequently, referring to FIG. 9A, FIG. 9B, FIG. 10A, and FIG. 10B, parts of the manufacturing process in the first embodiment will be described. FIG. 9A and FIG. 9B schematically illustrate a case of manufacturing the body having the thermal radiation fins by an aluminum alloy-made die-cast molding. FIG. 9A illustrates the first embodiment, and FIG. 9B illustrates the comparative example. In the drawings, illustration of concavities and convexities of the die corresponding to the thermal radiation fins is omitted.

FIG. 10A and FIG. 10B schematically illustrate a case of applying spray coating on the surface of the body manufactured by the die-cast molding. FIG. 10A illustrates the first embodiment, and FIG. 10B illustrates the comparative example.

### Die-Cast Molding

When manufacturing the body 1 having the plurality of thermal radiation fins 13 as in the first embodiment, light metal such as aluminum or magnesium which has desirable thermal conductivity and allows reduction in weight is used in general. Processing such as press working is difficult, and a method of processing through the die-cast molding is applied.

As illustrated in FIG. 9A, melted aluminum alloy is flowed into upper and lower molds in the drawing, is cooled in the molds to form the shape (the left drawing), then the molds are opened by sliding upward and downward, and a molded piece (the body 1) in the mold is taken out (right drawing).

In this case, in the first embodiment, the thermal radiation fins 13 have dimensions such that the connecting length Lb connected to the base unit 11 is formed to be larger than the connecting length La of a portion connected to the cylindrical portion 12, and hence the improvement of the thermal radiating property is achieved. Therefore, the width to slide the molds to open is small (see the right drawing), and hence the time required for opening and closing the molds is short and the tact time is reduced, so that improvement of productivity is enabled.

In contrast, as illustrated in FIG. 9B, when the height of thermal radiation fins 13′ is increased extending toward the back side to improve the thermal radiation property, the width to slide the molds to open is long (see the right drawing, and hence the time required for opening and closing the molds is long, and the tact time is increased, so that cost increases may be resulted with disadvantageous productivity.

As described above, according to the configuration of the first embodiment, improvement of the productivity is achieved when manufacturing the body 1 having the plurality of thermal radiation fins 13.

### Spray Coating

In order to improve, for example, the appearance, the corrosion resistance, and the thermal radiating property of the surface of the body, spray coating is performed. The spray coating is performed by atomizing paint and spraying the paint from a nozzle onto the surface of the body together with high-pressure air.

As illustrated in FIG. 10A, the paint is sprayed onto the body 1 from above and below and toward the groove portions between the thermal radiation fins 13 from below. In such a case, the height of the thermal radiation fins 13 is formed to be small, and the paint enters gaps between the respective thermal radiation fins 13 to coat the same.

In contrast, as illustrated in FIG. 10B, when the height of the thermal radiation fins 13′ is large, the paint can hardly enter the gaps between the respective thermal radiation fins 13′ and the necessity of spraying the paint from the side is also necessary. Therefore, the trouble of the coating work is increased, and the risk of lowering of the productivity arises.

Therefore, according to the configuration of the first embodiment, the paining work is simplified and the improvement of the productivity is achieved.

As described above, according to the first embodiment, the light-emitting module suitable for securing the insulation performance and achieving improvement of the thermal radiation property, and the lamp apparatus and the luminaire using the light-emitting module may be provided.

### Second Embodiment

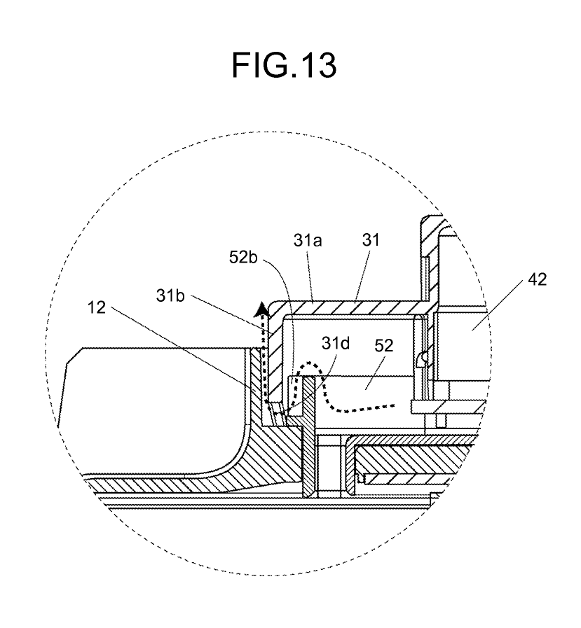

Subsequently, a second embodiment relating to the formation of the air-ventilation route will be described with reference to FIG. 12 and FIG. 13. FIG. 12 illustrates the insulating member, and FIG. 13 is an enlarged drawing corresponding to FIG. 4. The same or equivalent parts as the first embodiment are denoted by the same reference numerals and overlapped descriptions are omitted.

As illustrated in FIG. 12, the insulating member 5 has the similar configuration as the first embodiment. However, in the upright portion 52, substantially square-shaped depressions 52b depressed inward are formed at intervals of 120° at three positions.

As illustrated in FIG. 13, the depressions 52b of the upright portion 52 are positioned so as to face the air-ventilation ports 31d, and a non-linear portion of the air-ventilation path is formed by the depressions 52b.

Therefore, as illustrated by an arrow, the air-ventilation path extends from the lighting circuit components 42 in the horizontal direction, is inhibited in its linearity by a wall surface of the depressions 52b of the upright portion 52, climbs over the depressions 52b and proceeds toward the air-ventilation ports 31d, passes through the air-ventilation ports 31d, and through a gap between the outer peripheral side of the side wall 31b of the cap unit body 31 and the inner peripheral side of the cylindrical portion 12 of the body 1, proceeds to the outside.

According to the non-linear air-ventilation route, the route becomes complicated and hence the outflow of the evaporative gas flowing out from the lighting circuit components 42 in the smoke state is restricted further effectively.

As described thus far, the lamp apparatus and the luminaire according to the embodiments having the configuration as described above include the body, the light-emitting module, the lighting device, the cap unit, and the insulating member. The body has thermal conductivity, and is provided with the base unit, the cylindrical portion extending upright in the substantially cylindrical shape from the back side of the base unit, and the plurality of thermal radiation fins formed on the back side of the base unit. The light-emitting module is disposed on the front side of the base unit of the body. The lighting device performs lighting control on the light-emitting elements, and is disposed inside the cylindrical portion of the body. The cap unit includes the pair of electrode pins and covers the lighting device. The insulating member is disposed inside the cylindrical portion of the body and includes the upright portion extending upright from a peripheral edge thereof. Therefore, the lamp apparatus and the luminaire suitable for securing the insulation performance and achieving improvement of the thermal radiation property may be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes may be made without departing from the spirit of the inventions. The accompanying claims and their equivalents are intended to cover such forms or modifications as would fall within the scope and spirit of the inventions.

What is claimed is:

1. A lamp apparatus comprising:
a body having thermal conductivity, and is provided with a base unit, a cylindrical portion extending upright in a substantially cylindrical shape from the back side of the base unit, and a plurality of thermal radiation fins formed on the back side of the base unit;
a light-emitting module disposed on the front side of the base unit of the body;
a lighting device configured to perform lighting control on the light-emitting element and disposed inside the cylindrical portion of the body;
a cap unit including a pair of electrode pins and configured to cover the lighting device; and
an insulating member disposed inside the cylindrical portion of the body and including an upright portion extending upright from a peripheral edge thereof.

2. The apparatus according to claim 1, wherein the cap unit includes an air-ventilation port defining a non-linear air-ventilation route communicating with the outside of the lamp apparatus.

3. The apparatus according to claim 2, wherein the cap unit includes a cylindrical side wall arranged inside the cylindrical portion of the body, and
the air-ventilation port is formed at an opening edge of the side wall.

4. The apparatus according to claim 2, wherein the upright portion of the insulating member includes a notched port positioned so as to oppose the air-ventilation port, and the notched port forms part of the non-linear air-ventilation route.

5. The apparatus according to claim 4, wherein a plurality of the notched ports and a plurality of the air-ventilation ports are formed.

6. The apparatus according to claim 2, wherein the upright portion of the insulating member includes a depression positioned so as to oppose the air-ventilation port and depressed inward of the insulating member, and the depression forms part of the non-linear air-ventilation route.

7. The apparatus according to claim 6, wherein a plurality of the depressions and the plurality of air-ventilation ports are formed.

8. The apparatus according to claim 2, wherein the cap unit includes a cylindrical side wall arranged inside the cylindrical portion of the body, and a gap between the outer peripheral side of the side wall and the inner peripheral side of the cylindrical portion of the body define part of the non-linear air-ventilation route.

9. The apparatus according to claim 8, wherein the non-linear air-ventilation route extends from a lighting circuit component of the lighting device toward the air-ventilation port via the upright portion, passes through the gap between an outer peripheral side of the side wall of the cap unit and an inner peripheral side of the cylindrical portion of the body, and proceeds toward the outside.

10. The apparatus according to claim 1, wherein the thermal radiation fins are connected to an outer periphery of the cylindrical portion and the back side of the base unit, and the connecting length with respect to the base unit is longer than the connecting length with respect to the cylindrical portion.

11. The apparatus according to claim 10, wherein the thickness of the base unit to which the thermal radiation fins are connected is larger than the thickness of the cylindrical portion.

12. The apparatus according to claim 1, wherein the light-emitting module includes:
a substrate, a wiring pattern layer formed so that a minimum distance from an outer peripheral end of the substrate becomes at least 4 mm, and a light-emitting element electrically connected to the wiring pattern layer and mounted on the substrate, and
the ratio of a surface area of the substrate with respect to a surface area of an area in which the wiring pattern layer is formed is set to be 1+(4α²+2α(A+B))/AB or larger, where A and B are maximum widths of areas in which the wiring pattern layer along respective lines substantially orthogonal to each other on the substrate surface and α is the minimum distance from the outer peripheral end of the substrate to the wiring pattern layer.

13. A luminaire comprising:
the apparatus according to claim 1, and
a socket apparatus on which the cap unit of the lamp apparatus is demountably mounted.
